(19) United States
(12) Patent Application Publication
(10) Pub. No.: US 2009/0324058 A1
(43) Pub. Date: Dec. 31, 2009

(54) Use of geographic coordinates to identify objects in images

(76) Inventors: David A. Sandage, Forest Grove, OR (US); Edward R. Harrison, Beaverton, OR (US)

Correspondence Address: INTEL CORPORATION;c/o CPA Global, P.O. BOX 52050, MINNEAPOLIS, MN, 55402, US

(21) Appl. No.: 12/215,075

(22) Filed: Jun. 25, 2008

(51) Int. Cl. G06K 9/00

(52) U.S. Cl. 382/154

(57) ABSTRACT

A method and device are disclosed. In one embodiment the method includes determining the location of a camera when the camera captures an image. The method continues by determining the viewable subject area of the image. Additionally, the method determines the location of one or more objects at the time the image is taken. Finally, upon making these determinations, the method concludes by identifying each of the one or more objects as being in the image when the location of each of the one or more objects is calculated to have been within the viewable subject area of the image at the time the image was taken.

### FIELD OF THE INVENTION

The invention relates to identifying objects as being in an image using geographic coordinates.

### BACKGROUND OF THE INVENTION

Digital cameras that record geographic coordinates into the EXIF (Exchangeable Image File Format) header of the photographs are starting to enter at the high-end of the market. Supplemental GPS (Global Positioning System) hardware is available in the market for a number of consumers who are manually “geotagging” their photographs (i.e. the supplemental hardware modifies the EXIF headers of photographs based on geographic data from external GPS devices). Geotagged photos are being used on the web to create a variety of new rich experiences. Geotagging is the process of adding geographical identification metadata to various media such as websites or images and is a form of geospatial metadata. This data usually consists of latitude and longitude coordinates, though it can also include altitude, bearing, and place names.

There is nascent technology available to perform face recognition on a photograph to determine the name of the individual. This technology only works where there is a clear frontal view of the individual with appropriate lighting and exposure. Additionally, the technology currently works primarily with people, not objects or animals.

Location technology is being deployed in a wide variety of devices, many of which we carry on our persons (cell phones, digital cameras, navigation devices, child and pet locator devices, etc). Location is based on number of technologies such as GPS (global positioning system), cell network triangulation, IEEE (Institute of Electrical and Electronics Engineers) 802.11 beacon-based, etc.

There are digital compasses and digital inclinometers that can be used to determine the orientation of a person or thing by determining direction and inclination, respectively.

### BRIEF DESCRIPTION OF THE DRAWINGS

The present invention is illustrated by way of example and is not limited by the drawings, in which like references indicate similar elements, and in which:

FIG. 1 describes an embodiment of an image and each object that may be identified as being in the image.

FIG. 2 describes multiple embodiments of a device to identify objects as being in digital media utilizing geographic locations.

FIG. 3 is a flow diagram of an embodiment of a process to identify an object as being in an image using location information.

### DETAILED DESCRIPTION OF THE INVENTION

Embodiments of a method and device for identifying objects as being in an image are disclosed. Today images are captured with cameras, video cameras, and other devices. These devices may be digital or analog. Furthermore, a captured image may include a picture, a frame of a video, a sequence of frames (i.e. a video), a hologram, or more generally, any data that can be captured and viewed. The image is stored in some form of graphical media. For example, the image can be stored digitally in some form of storage device (e.g. a flash memory device).

A common device that captures images is a digital camera that takes digital pictures. When a digital camera captures an image it generally will record the image onto a memory storage device located in the camera. Digital pictures are commonly taken of one or more subjects (i.e. objects of focus) in a particular environment. For example, digital pictures may record people, animals, automobiles, trains, houses, buildings, landmarks, bodies of water, hills, mountains, and a great deal of other objects and environments. Some of these objects may have the ability to report a set of geographic coordinates of their location, such as a person carrying a global positioning system (GPS) device or the geographic features of a mountain being stored in a topographic database.

The camera taking the picture may include electronic features such as a digital compass to determine the direction the camera is pointing (e.g. an azimuth detector), an inclinometer (to detect the up/down tilt of the camera), a geographic location determination device (e.g. an internal GPS device), as well as potentially one or more other internal devices for retrieving additional information. This information related to the camera may be utilized to determine a specific viewable subject area, which is the physical area in three-dimensional space that the picture is taken of. This viewable subject area is associated with a time (i.e. time of day and date) that the picture was taken. By cross-referencing the viewable subject area of the picture with the geographic coordinates of one or more objects (e.g. a person with a GPS device) at the time the picture is taken, objects may be identified as being in the picture.

Reference in the following description and claims to “one embodiment” or “an embodiment” of the disclosed techniques means that a particular feature, structure, or characteristic described in connection with the embodiment is included in at least one embodiment of the disclosed techniques. Thus, the appearances of the phrase “in one embodiment” appearing in various places throughout the specification are not necessarily all referring to the same embodiment. In the following description and claims, the terms “include” and “comprise,” along with their derivatives, may be used, and are intended to be treated as synonyms for each other.

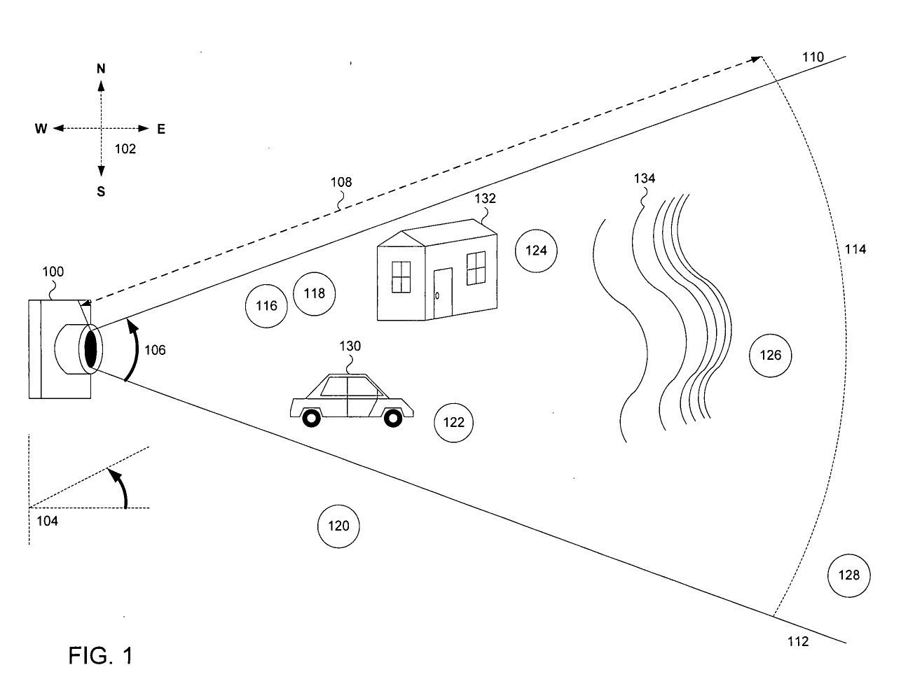

FIG. 1 describes an embodiment of an image and each object that may be identified as being in the image. Each object in FIG. 1 has particular location data associated with it and some objects have time data associated with them. In some embodiments, the location data may include worldwide geographic coordinate data with latitude and longitude data (and potentially altitude data). Though there may be other geographic coordinate data systems that would be utilized.

Although the embodiments in general utilize a camera as the device that captures the image, as mentioned above, in other embodiments not shown, the device capturing the image may be a video camera or another image capturing device. Turning to FIG. 1, at some point in time, a camera 100 captures an image. At the time the image is taken certain information is determined by logic within the camera 100. The camera 100 is pointing in a specific XY-plane direction 102 (i.e. an azimuth direction), which utilizes north, south, east, west directions (e.g. 2 degrees north of due east). The camera direction also may include an inclination direction 104 (e.g. the direction in the Z-plane), which utilizes the angle the camera is pointing up or down versus a theoretical horizon. Additionally, the camera has a particular angle of view 106 that may change based on the camera lens and zoom ability (e.g. a narrow, zoomed view versus a wide-angle lens view). In many embodiments, the camera also has a focal distance 108, which is the distance from the lens that the camera can maintain focus or discern objects.

The XY-plane direction 102, Z-plane direction 104, the camera's angle of view 106, and the focal distance 108 are parameters that make up the viewable subject area of the image. In the 2-dimensional figure shown in FIG. 1, the viewable subject area is partially shown by framed lines 110 and 112 as well as arc 114. In a true three dimensional environment that a real camera would be capturing an image of, the viewable subject area may look similar to a cone, where the apex of the cone is the camera lens and arc 114 describes a distended base since the height of the cone from any point at the base up to the apex is the focal length, which is a fixed value. In other embodiments, the focal distance may not exist and the camera observes the world with an infinite focal distance. In yet other embodiments, the viewable subject area is another shape entirely that may be utilized to better adjust to limitations for a specific camera.

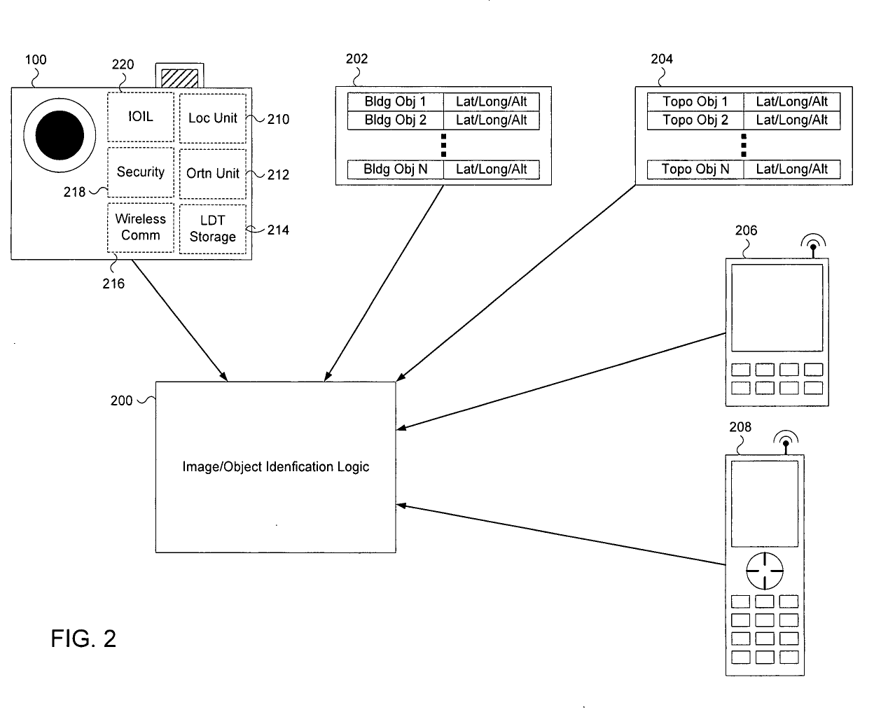

In the context of the image, an “object” that may be identified to be within the viewable subject area or outside of the viewable subject area can be any real or imaginary entity. In many embodiments, entities are limited to real objects that can be potentially visually documented within the context of the image. Examples of objects are people, animals, automobiles, airplanes, houses, commercial buildings, trees, waterfalls, lakes, mountains, among many others. In the example shown in FIG. 2, objects 116, 118, 120, 122, 124, 126, and 128 are people, object 130 is an automobile, object 132 is a house, and object 134 is a hill (shown with topographic lines).

Thus, in the embodiment shown in FIG. 1, when camera 100 captures an image, logic within the camera determines the viewable subject area from the geographic coordinate location of the camera, the XY-direction the camera is pointing (102), the Z-direction the camera is pointing (104), the angle of view of the camera (106), and the focal distance (108) of the camera. In addition to the information listed above, the camera also determines at what time the image was taken (e.g. time of day and calendar date).

Additionally, one or more of the objects in the image shown in FIG. 1 may have the capability to determine their own geographic location coordinates. For example, person object 116 may be holding a GPS device or another location determination device. In many embodiments, the location determination device on person object 116 also has the capability to track its location over time and store a history of the device's location in time increments. Other people objects as well as other movable objects that are not people (e.g. automobile object 130) may also have location determination devices. In some embodiments, immovable objects, such as house object 132 and mountain object 134 may not have a location determination device and rather have their immovable locations stored within one or more databases, such as a structure and landmark location database or a topographic database. These objects presumably do not move and as such, would not require a location determination device to update their locations. Thus, a database that contains their permanent geographic location coordinates can be utilized.

In many embodiments, an object shown in FIG. 1 may be identified as being in the image when the object's geographic location is determined to be within the three-dimensional space of the image that comprises the viewable subject area at the time the image is taken.

In many embodiments, objects found to be within the viewable subject area of the image are always identified as objects within the image whether they are physically visible or not from the point of view of the camera. For example, person object 116 may be completely obstructing person object 118 from being visible in the embodiment shown in FIG. 1. Thus, person object 118 may be identified as being in the image even though the image does not physically show person object 118. Other examples of obstructed objects within the viewable subject area include person object 122 being obstructed by car object 130, person object 124 being obstructed by house object 132, and person object 126 being obstructed by mountain object 134.

Apart from objects in the camera's vicinity that are determined to be within the viewable subject area, there also may be one or more objects within the vicinity of the camera that are outside of the viewable subject area. Examples of these objects are person objects 120 and 128. Thus, in many embodiments, person objects 120 and 128 may not be identified as being in the image.

In other embodiments, even when an object is outside of the viewable subject area of the image, if the object is within a reasonable range, the object may still be identified as being reasonably close to being in the image. For example, if person object 120 is a good friend of the person capturing the image, object 120 may be identified as being just out of the frame to the right.

FIG. 2 describes multiple embodiments of a device to identify objects as being in digital media utilizing geographic locations. Image/object identification logic (IOIL) 200 includes logic to identify objects as being in images. IOIL 200 can be located in a computer system that is mobile or immobile in different embodiments. Some examples of where IOIL 200 may be located are within a server at a centralized data center, within a desktop computer at a person's home or at a retail establishment, or within a portable electronic device such as a laptop or a personal digital assistant.

In some embodiments, IOIL 200 may be logic implemented in software that is stored in a memory subsystem within the computer system IOIL 200 is a part of. In other embodiments, IOIL 200 may comprise hardwired circuitry, such as circuitry within a microcontroller located within a personal digital assistant.

IOIL 200 receives information from multiple sources to perform its major task, which is to identify objects as being in images. Some of the many objects that may supply information to IOIL 200 is camera 100, structure and landmark database 202, topographic database 204, GPS (global positioning system) device 206, and cellular phone 208. These are just examples of objects that may communicate with IOIL 200. Additional devices that are not shown may be an automobile, an airplane, household equipment, adventure gear, personal clothing and effects, among other objects.

The camera 100 may be one of many different types of digital cameras that digitally stores images in files. These files can be of any known type of image file such as a GIF, JPG, BMP, MPG, etc. The structure and landmark database 202 and topographic database 204 each include information stored within any known type of database. For example, the structure and landmark database 202 may be located within a server at a datacenter running an enterprise database. An additional example might be a local database stored in a table residing in a file located in the camera 100. GPS device 206 may be a handheld GPS device that is utilized to pinpoint the location where the GPS device is at any given moment. Another GPS-type device may be integrated into a car or airplane. These devices provide the same location data, but may not be as discretely visible as GPS device 206. Additionally, cellular phone 208 may have a GPS device internally located to provide the same information to the cellular phone user. In other embodiments, device 206 and cellular phone 208 do not utilize GPS signals for location purposes and instead operate utilizing a different technology. For example, the cellular phone may be able to provide location data utilizing existing cellular service with a signal triangulation algorithm that pinpoints the phone location between multiple cellular towers. Other potential location determination technologies may also be utilized in other embodiments.

In many embodiments, the structure and landmark database 202 stores the name of the structure or landmark and the geographic coordinates of the structure or landmark. In some embodiments, in addition to these two pieces of information, the structure and landmark database 202 also stores the size of the structure or landmark extending out from the central geographic coordinate location. In some embodiments, the structure and landmark database 202 also stores the elevation (e.g. height above/below sea level) of the structure or landmark.

In many embodiments, the topographic database 204 stores a large number of geographic coordinates, each with an elevation, to create a detailed topographic map. In some embodiments, the topographic database 204 is utilized in combination with the structure and landmark database 202 to allow for elevation information per structure or landmark.

For any of these objects to effectively communicate with IOIL 200, some form of communication channel is required. In different embodiments, this can range from wired interconnects (such as a Universal Serial Bus link) to a range of wireless networks and technologies(such as Bluetooth or an 802.11 protocol-based network). In many embodiments, the type of communication channel(s) utilized between these listed objects and IOIL 200 is dependent on the particular embodiment of IOIL 200 (i.e. located in a data center server, in a personal digital assistant, etc.).

To identify objects as being in a particular image captured by the camera 100, IOIL 200 requires several pieces of data to compute whether each object can be identified as being in the image.

In many embodiments, the camera is capable of receiving information regarding each object listed in FIG. 1, from object 116 to object 134. The information received may include the name of each object and the geographic location coordinates of each object at least at the time the image was captured. In many embodiments, each immovable object, such as the house 132 and the mountain 134 in FIG. 1 do not require time information since they will be at their geographic locations regardless of the time of day or the date. For each movable object (i.e. the people and the car) the object name, location, and time information can either be sent to the camera specifically for the time the image was captured or for a range of times, for which the camera can select the particular time and corresponding location.

In some embodiments, the camera can send a request for identity, location, and time information to each movable object at the time the image is captured. For example, when the user of the camera clicks the capture button on the camera to capture an image, the camera can immediately send out a wireless request to any objects in the vicinity that have location and time determination capabilities, such as a person who has a GPS device in his or her pocket. Each location and time determination capable object that receives the request captures the immediate location information and associated time and may send the information back to the camera along with the identity of the object.

In other embodiments, the camera does not send out an immediate request to any objects, but rather each of the objects has memory storage that captures a history of its location over the course of a period of time (e.g. a day). This object information, along with the identity of the object, can be utilized at a later time (e.g. the end of the day) in a calculation to identify each object as being in the image. The camera can also upload each image captured over the course of the same period of time with each image's corresponding information (e.g. the camera direction, focal distance, etc).

When the IOIL has received all camera information for a given image, and information from one or more objects that specifies where the object's location is at the time the image was captured and the identity of the object, the IOIL can then utilize that information to identify each object in the image. In other words, if an object's location at the time the image was captured was in the viewable subject area of the image, then the IOIL can positively identify the object as being in the image.

Any object positively identified as being in a image can have its information saved within or related to the image. The information can be saved within a header or footer in the image file (e.g. an EXIF (Exchangeable Image File Format) header). Alternatively, the information can be saved in a separate file that is associated with the particular image file. In other embodiments, the information can be saved in a relational image database as data relating to a particular image file. In many embodiments, when an object is identified as being in the image, the information associated with the object may be referred to as metadata. For example, in FIG. 1, the metadata for the image shown in FIG. 1 may include the name, location, and time for person object 116 since object 116 is within the viewable subject area of that particular image.

For each object that is identified as being in a particular image, the amount of information stored may differ in different embodiments. For example, in one embodiment, object information may be limited to the simple fact that the object in question is within the viewable subject area of the image. In other embodiments, each object within the image may be labeled with the name of the object in a call-out box added into the actual image file.

Returning to FIG. 2, in some embodiments, a IOIL 220 is located within the camera 100 instead of within a discrete device such as IOIL 200. Thus, in the embodiment where the camera sends out a request to each of the one or more objects in the vicinity to receive object location and time information, the IOIL 220 within the camera 100 can make the identification calculations per object related to a particular image and store the results in real-time with the image being stored. Thus, the entire set of image/object identification calculations may be done in real-time per image as the image is captured. In some embodiments, due to the independent nature of the camera and each of the objects identified as being in a image, the information received from one or more of the objects may arrive with a slight delay versus the information from the camera 100. Thus, in some embodiments, the camera 100 may include a memory buffer to temporarily store information per image. The IOIL 220 within the camera may perform the calculations once all relevant information has been received and is stored in the memory buffer.

In many embodiments, the camera includes a location unit 210 which provides the camera with the geographic coordinate location of the camera. In many embodiments, the camera also includes an orientation unit 212. The orientation unit may include an internal digital compass and an internal inclinometer to determine the direction the camera is pointing in XYZ three-dimensional space.

Additionally, in many embodiments, the camera includes some form of storage that can store the location of the camera when a image is captured, the direction the camera is pointing when the image is captured, the time when the image is captured, as well as many other potential storage information (e.g. focal distance of the captured image). This storage, such as Location/Direction/Time (LDT) storage 214 may comprise a flash memory chip, a writeable compact disc, or another type of non-volatile storage medium. In some embodiments where the camera communicates wirelessly with at least one of the one or more objects in the vicinity of the image, the camera also requires a wireless communication device 216 that may utilize any standard or proprietary type of wireless communication protocol.

In some embodiments, the camera includes a security device 218 that will only allow the camera to receive name and location information for objects that have a trusted relationship with the camera. Thus, when the camera sends requests to objects, the security device 218 may allow for a secure network connection that creates a trusted relationship between the camera and a particular object if the object and the camera are trusted friends. In many embodiments, an object that utilizes a location determination device (such as GPS) also has a security device (not pictured) similar to security device 218, which provides for a certificate to secure a network connection from the object as well. In other words, in some embodiments, the camera may maintain a trusted social network with one or more objects that have been identified as friends within the trusted social network. This prevents unauthorized and unknown cameras from receiving name and location information from objects within a local vicinity.

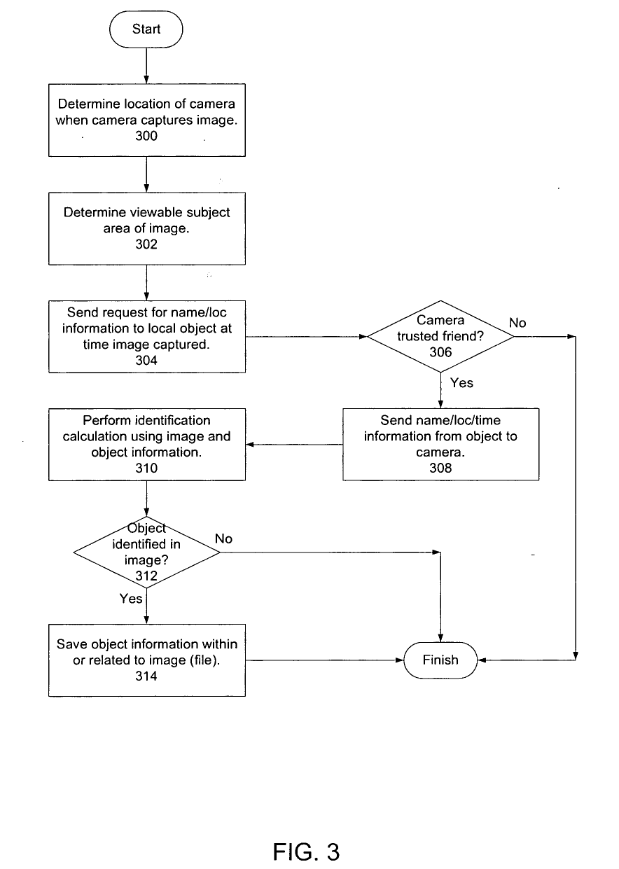

FIG. 3 is a flow diagram of an embodiment of a process to identify an object as being in an image using geographic location information. The process is performed by processing logic which may comprise software, hardware, or a combination of both. Additionally, processing logic is not restricted to running in a single device, such as the camera, but may be running on the camera, in a PDA, in a server, etc. Turning to FIG. 3, the process begins with processing logic determining the location of a camera when the camera captures an image (processing block 300).

Then processing logic determines the viewable subject area of the image (processing block 302). Next, processing logic sends a request for the name and location information to a local object at the time the image is captured (processing block 304). This portion of the process may be expanded to perform multiple times for however many objects are in the local vicinity, although the process shown specifically in FIG. 3 is only for a single object. Depending upon the particular embodiment, the name and location information about each object may be retrieved directly from the object itself or may be obtained from a storage medium separate from the object such as a database in a data center.

Processing logic then determines whether the camera is a trusted friend to the object (processing block 306). If the camera is not a trusted friend (i.e. the camera is not in the trusted social network of the object), then the process is finished for this particular object because the object will not send information revealing its name and location.

Otherwise, if the camera is a trusted friend, then processing logic sends the name, location, and time information from the object to the camera (processing block 308). Then processing logic performs the identification calculation to determine whether the object is identified as being in the image using the determined location of the camera, the determined viewable subject area of the image, and the name, location, and time information of the object (processing block 310).

Then, based on the identification calculation, processing logic determines whether the object is identified as being in the image (processing block 312). If the object is not identified as being in the image, then the process is finished. Otherwise, if the object is identified as being in the image, the processing logic saves the object information within the image file that contains the image or in a location related to the image, such as a related file (processing block 314), and the process is finished.

Thus, embodiments of a method and device for identifying objects as being in images are disclosed. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
determining the location of a camera when the camera captures an image;
determining the viewable subject area of the image;
determining the location of one or more objects at the time the image is taken; and
identifying each of the one or more objects as being in the image when the location of each of the one or more objects is calculated to have been within the viewable subject area of the image at the time the image was taken.

2. The method of claim 1, further comprising:
storing the results of the determination of the location of the camera within the camera;
storing the results of the determination of the viewable subject area of the image within the camera;
sending results of the determination of the location of the one or more objects to the camera; and
performing, within the camera, the identification calculation of each of the one or more objects.

3. The method of claim 2, further comprising:
storing results of the identification calculation for each of the one or more objects that are identified as being in the image within the camera.

4. The method of claim 1, further comprising:
sending results of the determination of the location of the camera to a image object identification logic device, wherein the device is discrete from the camera and the one or more objects;
sending results of the determination of the viewable subject area of the image to the image object identification logic device;
sending results of the determination of the location of the one or more objects to the image object identification logic device; and
performing, within the image object identification logic device, the identification calculations of each of the one or more objects.

5. The method of claim 4, further comprising:
storing results of the identification calculation for each of the one or more objects that are identified as being in the image within the image object identification logic device.

6. The method of claim 1, further comprising:
sending a request, from the camera to the one or more objects, for the location of each of one or more objects;
sending information of the location of each of the one or more objects receiving the request from each of the one or more objects to the camera.

7. The method of claim 6, further comprising:
each of the one or more objects determining whether the camera is a trusted friend; and
each of the one or more objects sending information to the camera only when the camera has been determined to be a trusted friend.

8. The method of claim 1, further comprising:
storing metadata related to each object identified as being in the image in a location within a file that contains the image.

9. The method of claim 1, further comprising:
storing metadata related to each object identified as being in the image in a separate file associated with the digital image.

10. The method of claim 1, further comprising including a topographic database in the identification calculation of the viewable subject area to determine if one or more of the objects in the viewable subject area are behind a topographic obstruction.

11. The method of claim 1, further comprising including a structure location map in the identification calculation of the viewable subject area to determine if one or more objects in the viewable subject area are behind one or more structures.

12. A device, comprising:
image object identification logic to:
receive a location of a camera when the camera captures an image;
receive a time the image was taken;
receive information pertaining to the viewable subject area of the image;
receive a location of one or more objects at the time the image was taken; and
identify each of the one or more objects as being in the image when the location of each of the one or more objects is calculated to have been within the viewable subject area of the image at the time the image was taken.

13. The device of claim 12, wherein the image object identification logic is further operable to:
store information related to each of the one or more objects identified as being in the image.

14. The device of claim 13, wherein the image object identification logic is further operable to:
determine whether each of the one or more objects and the camera have a trusted relationship; and
store information related to each of the one or more objects identified as being in the image only for each object that has a trusted relationship with the camera.

15. The device of claim 12, wherein the image object identification logic is further operable to:
store information related to each of the one or more objects identified as being in the image as metadata within a file that contains the image.
